(19) United States
(12) Patent Application Publication
(10) Pub. No.: US 2016/0098154 A1
(43) Pub. Date: Apr. 7, 2016

(54) DISPLAY APPARATUS AND CONTROL METHOD THEREOF

(71) Applicant: SAMSUNG ELECTRONICS CO., LTD., Suwon-si (KR)

(72) Inventors: Hee-jin KO, Bucheon-si (KR); Yong-jin SO, Seongnam-si (KR); Chang-hoon PARK, Seoul (KR)

(73) Assignee: SAMSUNG ELECTRONICS CO., LTD., Suwon-si (KR)

(21) Appl. No.: 14/850,375

(22) Filed: Sep. 10, 2015

(30) Foreign Application Priority Data
Oct. 1, 2014 (KR) 10-2014-0132672

(51) Int. Cl. G06F 3/0481; G06F 3/0488; G06F 3/16; G06F 3/0484

(52) U.S. Cl. CPC G06F 3/0481; G06F 3/04845; G06F 3/04883; G06F 3/167; G06F 2203/04803; G06F 2203/04808; G06F 2203/04806

(57) ABSTRACT

A display apparatus includes: an inputter configured to receive a touch input of a user; a display configured to display a screen of a plurality of screens, wherein each screen corresponds to a depth according to a hierarchical structure; and a controller configured to, in response to a pinch gesture being received through the inputter, control the display to convert a currently displayed screen into a screen corresponding to a higher depth or a lower depth according to the pinch gesture. Accordingly, the display apparatus converts into a specific screen from among a plurality of screens having a hierarchical structure more intuitively, so that conversion to a specific screen can be achieved more easily and more rapidly.

### CROSS-REFERENCE TO RELATED APPLICATION(S)

This application claims priority from a Korean patent application filed on Oct. 1, 2014 in the Korean Intellectual Property Office and assigned Serial No. 10-2014-0132672, the entire disclosure of which is hereby incorporated by reference.

### BACKGROUND

1. Field

Apparatuses and methods consistent with exemplary embodiments relate to a display apparatus and a control method thereof, and more particularly, to a display apparatus that can convert a screen according to a user interaction (e.g., gesture), and a control method thereof.

2. Description of Related Art

Generally, when a touch is inputted through a touchscreen on an icon displayed in a specific location, a display apparatus through which a touch can be inputted converts into a screen corresponding to the icon.

For example, when a specific application is executed, the display apparatus displays an initial screen for the application. Therefore, the user may touch an icon displayed on one side of the display apparatus in order to convert the initial screen into an execution screen corresponding to a lower depth (e.g., level). If a plurality of screens are hierarchically formed between the execution screen to be executed and the initial screen, the user should touch corresponding icons as many times as the number of the plurality of screens in order to reach the corresponding execution screen.

In addition, an icon for converting into a screen corresponding to a lower depth on each screen may be displayed in a different location on each screen. In this case, the user may have a difficult time finding an icon for converting into a screen that the user wants to execute, and thus, there may be a problem with a screen not being rapidly converted.

### SUMMARY

One or more exemplary embodiments may overcome the above disadvantages and other disadvantages not described above. However, it should be understood that one or more exemplary embodiment are not required to overcome the disadvantages described above, and may not overcome any of the problems described above.

One or more exemplary embodiments provide easily converting into a specific screen from among a plurality of screens hierarchically formed in a display apparatus.

One or more exemplary embodiments also easily provide content information related to an execution screen on an application in the execution screen when the application is executed.

According to an aspect of an exemplary embodiment, there is provided a display apparatus including: an inputter configured to receive a touch input of a user; a display configured to display one screen of a plurality of screens, wherein each screen corresponds to a depth according to a hierarchical structure; and a controller configured to, in response to a pinch gesture being received through the inputter, control the display to convert a screen that is currently displayed into a screen corresponding to a higher depth than the screen that is currently displayed or a lower depth than the screen that is currently displayed, according to a type of the pinch gesture.

In response to an audio application being executed, the plurality of screens may include at least one of a list screen which provides a content list including contents corresponding to a plurality of speakers that are pre-registered, a control screen for controlling a speaker corresponding to a content selected from the plurality of contents included in the content list, and an information providing screen which provides information about an audio outputted through the speaker corresponding to the selected content.

In response to a two-finger pinch out gesture being received in a state in which the list screen is displayed, the controller may be configured to control the display to convert into the control screen, and, in response to a two-finger pinch out gesture being received in a state in which the control screen is displayed, the controller may be configured to control the display to convert into the information providing screen.

In response to a two-finger pinch in gesture being received in a state in which the information providing screen is displayed, the controller may be configured to control the display to convert into the control screen, and, in response to a two-finger pinch in gesture being received in a state in which the control screen is displayed, the controller may be configured to control the display to convert into the list screen.

In response to a three-finger pinch out gesture being received in a state in which the list screen is displayed, the controller may be configured to control the display to convert into the information providing screen, and, in response to a three-finger pinch in gesture being received in a state in which the information providing screen is displayed, the controller may be configured to control the display to convert into the list screen.

In response to a drag gesture being received in a state in which the list screen is displayed, the controller may be configured to set at least two contents from among the plurality of contents included in the list screen to be grouped into a same group, and, in response to a drag gesture being received in the state in which the at least two contents are grouped into the same group, the controller may be configured to ungroup the at least two contents that are grouped into the same group.

The display apparatus may further include a communicator configured to perform data communication with the plurality of speakers that are pre-registered via a relay apparatus, and, in response to a second content from among the plurality of contents being set to a same group as a first content from among the plurality of contents in a state in which an audio is outputted through a first speaker corresponding to the first content from among the plurality of contents, the controller may be configured to control the communicator to transmit same audio data to the first speaker and the second speaker, wherein the first speaker and the second speaker correspond to the first content and the second content, respectively.

In response to the first content and the second content being ungrouped in a state in which the audio outputted from the first speaker is the same as the audio outputted from the second speaker, the controller may be configured to control the communicator to transmit different audio data to the first speaker and the second speaker.

In response to audio being outputted from the first speaker and the second speaker corresponding to the first content from among the plurality of contents and the second content from among the plurality of contents, the controller may be configured to control the display to display the first content and the second content differently than the other contents.

The plurality of screens may further include a speaker list for controlling the plurality of speakers that are pre-registered, and the controller may be configured to perform audio setting on at least one of the plurality of speakers included in the speaker list according to a user command.

According to an aspect of another exemplary embodiment, there is provided a control method of a display apparatus, including: displaying one screen of a plurality of screens, wherein each screen corresponds to a depth according to a hierarchical structure; receiving a touch input of a pinch gesture; and in response to the pinch gesture being received, converting a screen that is currently displayed into a screen corresponding to a higher depth than the screen that is currently displayed or a lower depth than the screen that is currently displayed, according to the pinch gesture.

The control method may further include executing an audio application according to a user command, and the displaying the one screen may include, in response to the audio application being executed, displaying at least one of a list screen which provides a content list including contents corresponding to a plurality of speakers that are pre-registered, a control screen for controlling a speaker corresponding to a content selected from the plurality of contents included in the content list, and an information providing screen which provides information about an audio outputted through the speaker corresponding to the selected content.

The displaying may include, in response to a two-finger pinch out gesture being received in a state in which the list screen is displayed, converting into the control screen, and, in response to a two-finger pinch out gesture being received in a state in which the control screen is displayed, converting into the information providing screen.

The displaying may include, in response to a two-finger pinch in gesture being received in a state in which the information providing screen is displayed, converting into the control screen, and, in response to a two-finger pinch in gesture being received in a state in which the control screen is displayed, converting into the list screen.

The displaying may include, in response to a three-finger pinch out gesture being received in a state in which the list screen is displayed, converting into the information providing screen, and, in response to a three-finger pinch in gesture being received in a state in which the information providing screen is displayed, converting into the list screen.

The control method may further include: in response to a drag gesture being received in a state in which the list screen is displayed, setting at least two contents from among the plurality of contents included in the list screen to be grouped into a same group; and in response to a drag gesture being received in the state in which the at least two contents are grouped into the same group, ungrouping the at least two contents that are grouped into the same group.

The control method may further include transmitting audio data to a speaker corresponding to at least one of the plurality of contents according to a user command, and the transmitting the audio data may include, in response to a second content from among the plurality of contents being set to a same group as a first content from among the plurality of contents in a state in which an audio is outputted through a first speaker corresponding to the first content from among the plurality of contents, transmitting same audio data to the first speaker and second speaker, wherein the first speaker and the second speaker correspond to the first content and the second content, respectively.

The transmitting the audio data may include, in response to the first content and the second content being ungrouped in a state in which the audio outputted from the first speaker is the same as the audio outputted from the second speaker, transmitting different audio data to the first speaker and the second speaker.

The displaying the one screen may include, in response to audio being outputted from the first speaker and the second speaker corresponding to the first content from among the plurality of contents and the second content from among the plurality of contents, displaying the first content and the second content differently than the other contents.

The plurality of screens may further include a speaker list for controlling the plurality of speakers that are pre-registered, and the executing the audio application may include performing audio setting on at least one of the plurality of speakers included in the speaker list according to a user command.

According to an aspect of another exemplary embodiment, there is provided a method for controlling a plurality of speakers, the method including displaying one screen of a plurality of screens, wherein each screen corresponds to a depth according to a hierarchical structure; identifying, for each content from among a plurality of contents, a speaker from among the plurality of speakers, that corresponds to each content; receiving a gesture input; converting from a screen that is currently displayed to a screen having a different depth in the hierarchical structure, according to a type of the received gesture input.

In response to the received gesture input being a two-finger pinch out gesture when the screen that is currently displayed is a list screen for listing a plurality of contents, the method may include converting to a control screen for controlling an audio feature of an audio stream, and in response to the received gesture input being a two-finger pinch out gesture when the screen that is currently displayed is the control screen, converting to an information providing screen for providing information about an audio outputted through the speaker that corresponds to the content displayed on the control screen.

In response to the received gesture input being a two-finger pinch in gesture when the screen that is currently displayed is an information providing screen for providing information about an audio outputted through the speaker that corresponds to the content, the method may include converting to a control screen for controlling an audio feature of an audio stream, and in response to the received gesture input being a two-finger pinch in gesture when the screen that is currently displayed is the control screen, converting to a list screen for listing a plurality of contents.

In response to the received gesture input being a three-finger pinch out gesture when the screen that is currently displayed is a list screen for listing a plurality of contents, the method may include converting to an information providing screen for providing information about an audio outputted through the speaker that corresponds to the content.

In response to the received gesture input being a three-finger pinch in gesture when the screen that is currently displayed is an information providing screen for providing information about an audio outputted through the speaker that corresponds to the content, the method may include converting to a list screen for listing a plurality of contents.

According to one or more exemplary embodiments, the display apparatus converts into a specific screen from among a plurality of screens having a hierarchical structure more intuitively, so that conversion to a specific screen can be achieved more easily and more rapidly.

### BRIEF DESCRIPTION OF THE DRAWINGS

The above and/or other aspects, features, and advantages of exemplary embodiments will be more apparent from the following description taken in conjunction with the accompanying drawings, in which:

FIG. 1 is a view illustrating a speaker control system according to an exemplary embodiment;

FIG. 2 is a block diagram illustrating a display apparatus according to an exemplary embodiment;

FIG. 3 is a view illustrating an example of a list screen which provides a content list in a display apparatus according to an exemplary embodiment;

FIG. 4 is a view illustrating an example of converting into a screen corresponding to a lower depth according to a pinch out interaction in a display apparatus according to an exemplary embodiment;

FIG. 5 is a view illustrating an example of converting into a screen corresponding to a lowermost depth according to a pinch out interaction in a display apparatus according to an exemplary embodiment;

FIG. 6 is a view illustrating an example of converting into a screen corresponding to a lowermost depth according to a three-finger pinch out interaction in a display apparatus according to an exemplary embodiment;

FIG. 7 is a view illustrating an example of converting into a screen corresponding to an upper depth according to a pinch in interaction in a display apparatus according to an exemplary embodiment;

FIG. 8 is a view illustrating an example of converting into a screen corresponding to an uppermost depth according to a pinch in interaction in a display apparatus according to an exemplary embodiment;

FIG. 9 is a view illustrating an example of converting into a screen corresponding to an uppermost depth according to a three-finger pinch in interaction in a display apparatus according to an exemplary embodiment;

FIG. 10 is a view illustrating an example of setting a same group according a drag interaction in a display apparatus according to an exemplary embodiment;

FIG. 11 is a view illustrating an example of negating the group setting to the same group according to a drag interaction in a display apparatus according to an exemplary embodiment;

FIG. 12 is a view illustrating an example of converting into a webpage screen corresponding to a lower depth according to a pinch out interaction in a display apparatus according to an exemplary embodiment;

FIG. 13 is a view illustrating an example of converting into a webpage screen corresponding to an upper depth according to a pinch in interaction in a display apparatus according to an exemplary embodiment;

FIG. 14 is a view illustrating an example of setting pre-registered speakers in a display apparatus according to an exemplary embodiment;

FIG. 15 is a view illustrating an example of a speaker list in which speaker setting for speakers pre-registered in the display apparatus is completed according to an exemplary embodiment.

FIG. 16 is a flowchart illustrating a method of controlling according to a user interaction in a display apparatus according to an exemplary embodiment;

FIG. 17 is a flowchart illustrating a method of converting into a screen corresponding to a lower depth according to a pinch out interaction in a display apparatus according to an exemplary embodiment;

FIG. 18 is a flowchart illustrating a method of converting into a screen corresponding to an upper depth according to a pinch in interaction in a display apparatus according to an exemplary embodiment; and

FIG. 19 is a flowchart illustrating a method for setting a group according to a drag interaction in a display apparatus according to an exemplary embodiment.

### DETAILED DESCRIPTION

One or more exemplary embodiments may be modified in many ways. Accordingly, it should be understood that the present disclosure is not limited to any particular exemplary embodiment, but includes all modifications, equivalents, and substitutions without departing from the scope and spirit of the inventive concepts. Also, well-known functions or constructions may not be described in detail if it would obscure the disclosure with unnecessary detail.

Hereinafter, exemplary embodiments will be described in greater detail with reference to the accompanying drawings, in which like reference numerals will be understood to refer to like parts, components and structures throughout. Also, it is understood that expressions such as “at least one of,” when preceding a list of elements, modify the entire list of elements and do not modify the individual elements of the list.

Although the terms including an ordinal number such as first, second, etc., can be used for describing various elements, the structural elements are not restricted by the terms. The terms are only used to distinguish one element from another element. For example, without departing from the scope of the present disclosure, a first structural element may be named a second structural element. Similarly, the second structural element also may be named the first structural element.

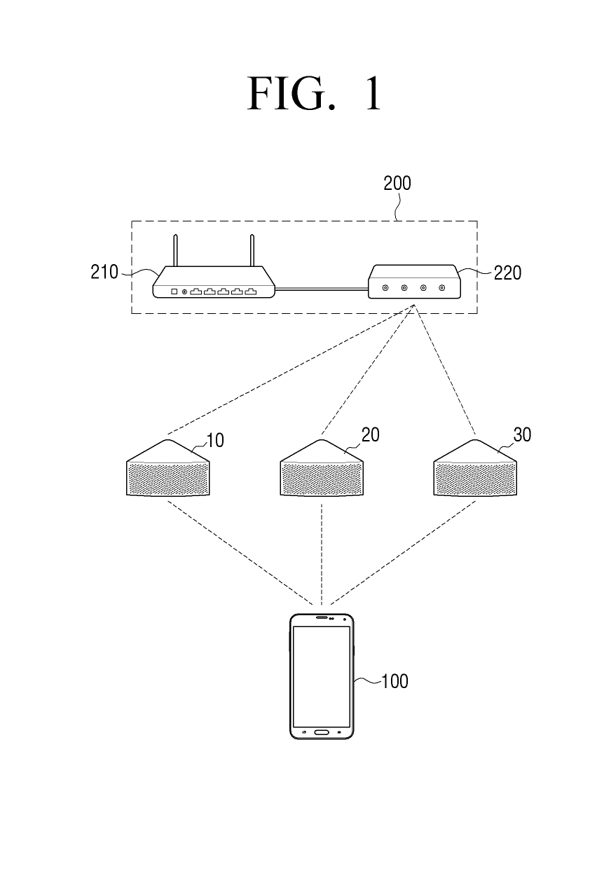

FIG. 1 is a view illustrating a speaker control system according to an exemplary embodiment.

As shown in FIG. 1, the speaker control system includes a plurality of speakers 10, 20, and 30, a display apparatus 100, and a relay apparatus 200.

The plurality of speakers (hereinafter, referred to as first to third speakers) 10 to 30 receive audio data outputted from the display apparatus 100 by performing wired or wireless data communication with the relay apparatus 200, and amplify an audio signal on the received audio data and output an audio.

The relay apparatus 200 transmits the audio data outputted from the display apparatus 100 to at least one of the first to third speakers 10 to 30 by performing wired or wireless data communication with the first to third speakers 10 to 30 and the display apparatus 100. The relay apparatus 200 may include at least one of an Access Point (AP) apparatus 210 and a hub apparatus 220. The AP apparatus 210 may perform data communication with at least one of the first to third speakers 10 to 30 and the display apparatus 100, and the hub apparatus 220 may perform data communication with at least one of the AP apparatus 210 and the first to third speakers 10 to 30.

The display apparatus 100 controls the first to third speakers 10 to 30 independently by performing data communication with the relay apparatus 200 wirelessly, and transmits the audio data to at least one of the first to third speakers 10 to 30. In this case, the display apparatus 100 may control at least one of the first to third speakers 10 to 30 in a state in which an audio application downloaded from an external apparatus is being executed. The display apparatus 100 is a terminal apparatus through which a user touch can be inputted, and for example, may be a smartphone, a tablet Personal Computer (PC), a smart television (TV), a laptop computer, a wearable device, etc.

According to an exemplary embodiment, the AP apparatus 210 and the hub apparatus 220 may be physically connected to each other via a wire cable and perform data communication. In addition, the AP apparatus 210 may perform data communication with the display apparatus 100 paired therewith using a short-distance wireless communication method such as Wi-Fi.

In response to power being supplied from an external source, the first speaker 10 from among the first to third speakers 10 to 30 transmits a registration request message including its own identification information using a broadcasting method. In response to the registration request message being received from the first speaker 10, the hub apparatus 220 transmits the received registration request message to the AP apparatus 210, and, in response to a corresponding response message being received, transmits the received response message to the first speaker 10. In response to such a response message being received, the first speaker 10 turns on a Light Emitting Diode (LED) display light provided in a housing, so that the user can identify that the first speaker 10 has been networked with the AP apparatus 210. The second and third speakers 20, 30 may also be networked with the AP apparatus 210 through the above-described series of processes. Accordingly, the first to third speakers 10 to 30 may perform data communication with the display apparatus 100 via the AP apparatus 210 on the same network.

Meanwhile, in response to the registration request message of the first to third speakers 10 to 30 being received via the hub apparatus 220, the AP apparatus 210 transmits speaker information including the identification information of each of the first to third speakers 10 to 30 to the display apparatus 100 existing on the same network as the AP apparatus 210. Accordingly, the display apparatus 100 may display a speaker list based on the speaker information of each of the first to third speakers 10 to 30 received from the AP apparatus 210. Therefore, the user may perform an audio setting on at least one of the first to third speakers 10 to 30 with reference to the speaker list displayed on the screen of the display apparatus 100.

For example, the user may input a user command to the display apparatus 100 to set the first and second speakers 10, 20 to output a first audio and set the third speaker 30 to output a second audio with reference to the speaker list displayed on the screen of the display apparatus 100. In response to such a user command being inputted, the display apparatus 100 transmits an audio reproduction command including audio data to be outputted from each of the first to third speakers 10 to 30 to the AP apparatus 210. The AP apparatus 210 then transmits the audio reproduction command received from the display apparatus 100 to the hub apparatus 220, and the hub apparatus 220 transmits the received audio reproduction command to the first to third speakers 10 to 30. The first and second speakers 10, 20 then output the first audio based on the received audio reproduction command, and the third speaker 30 outputs the second audio based on the received audio reproduction command.

In response to a user command related to a volume adjustment on the first speaker 10 being inputted in a state in which the first and second audios are outputted through the first to third speakers 10 to 30, the display apparatus 100 transmits a volume adjustment command to the AP apparatus 210, and the AP apparatus 210 then transmits the received volume adjustment command to the hub apparatus 220. The hub apparatus 220 then transmits the volume adjustment command to the first speaker 10, and the first speaker 10 reduces or raises amplification of the audio signal to a size corresponding to the volume adjustment command received via the hub apparatus 220 and outputs the audio signal.

Elements of the speaker control system according to exemplary embodiments have been briefly explained above. Hereinafter, elements of the display apparatus 100 for controlling audio output of the plurality of speakers 10 to 30 according to exemplary embodiments will be explained in detail.

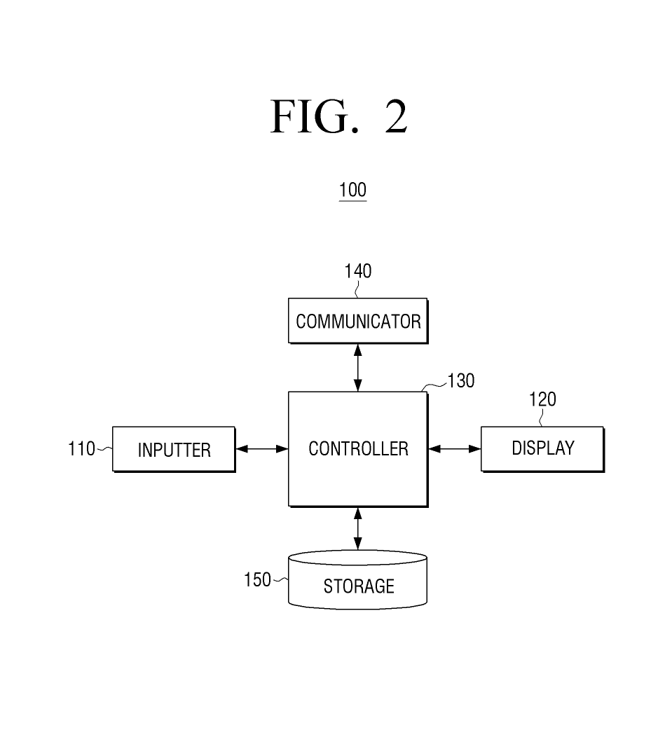

FIG. 2 is a block diagram illustrating a display apparatus according to an exemplary embodiment.

As shown in FIG. 2, the display apparatus 100 includes an inputter 110, a display 120, a controller 130, a communicator 140, and a storage 150 (e.g., memory).

The inputter 110 is configured to receive input of a user. The inputter 110 may receive input of a user's touch through a touch screen formed on the display 120 which displays a content. The user's touch may include at least one of a user's partial touch, a dragging gesture, and a user interaction related to pinch in or pinch out gesture on a specific area. In addition, the inputter 110 may receive input of a user command for controlling the operation of the display apparatus 100 through a key manipulator.

The display 120 displays a content image received from an external apparatus or a content image pre-stored in the storage 150. In particular, the display 120 may display one of a plurality of screens having a hierarchical structure. The display 120 may be implemented with a touch panel and receive a user touch.

The controller 130 may control the display 120 to convert a currently displayed screen into a screen corresponding to an upper depth or a lower depth according to an inputted pinch interaction in response to the pinch interaction being inputted through the inputter 110, and display the converted screen.

According to an exemplary embodiment, in response to an audio application being executed, the plurality of screens having the hierarchical structure to be displayed through the display 120 may include at least one of a list screen, a control screen, and an information providing screen. The list screen may be a screen which provides a content list including contents corresponding to a plurality of pre-registered speakers. In addition, the control screen may be a screen for controlling a speaker corresponding to a content selected from among the plurality of contents included in the content list. Also, the information providing screen may be a screen which provides information related to an audio outputted through the speaker corresponding to the selected content.

In response to a user interaction being inputted through the inputter 110 in a state in which one of the plurality of screens having the hierarchical structure is displayed, the controller 130 may control the display 120 to convert a currently displayed screen into a screen corresponding to an upper depth or a lower depth and display the converted screen according to exemplary embodiments.

According to an exemplary embodiment, in response to a first pinch out interaction being inputted in a state in which the list screen corresponding to the uppermost depth is displayed, the controller 130 may control the display 120 to convert the list screen into the control screen corresponding to a lower depth. According to such a control command, the display 120 converts the list screen into the control screen and displays the control screen, and then, in response to a second pinch out interaction being inputted, the controller 130 may control the display 120 to convert the currently displayed control screen into the information providing screen corresponding to the lowermost depth. According to such a control command, the display 120 may display the information providing screen corresponding to the lowermost depth.

According to an exemplary embodiment, in response to a first pinch in interaction being inputted in a state in which the information providing screen corresponding to the lowermost depth is displayed, the controller 130 may control the display 120 to convert the currently displayed information providing screen into the control screen corresponding to an upper depth. According to such a control command, the display 120 converts the information providing screen into the control screen and displays the control screen, and then, in response to a second pinch in interaction being inputted, the controller 130 may control the display 120 to convert the currently displayed control screen into the list screen corresponding to the uppermost depth and display the list screen. According to such a control command, the display 120 may display the list screen corresponding to the uppermost depth.

According to another exemplary embodiment, in response to a three-finger pinch out interaction being inputted in a state in which the list screen corresponding to the uppermost depth is displayed, the controller 130 may control the display 120 to convert the currently displayed list screen into the information providing screen corresponding to the lowermost depth. According to such a control command, the display 120 may convert the currently displayed list screen into the information providing screen corresponding to the lowermost depth and display the information providing screen.

According to an exemplary embodiment, in response to a three-finger pinch in interaction being inputted in a state in which the information providing screen corresponding to the lowermost depth is displayed, the controller 130 may control the display 120 to convert the currently displayed information providing screen into the list screen corresponding to the uppermost depth. According to such a control command, the display 120 may convert the currently displayed information providing screen into the list screen corresponding to the uppermost depth and display the list screen.

According to another exemplary embodiment, the controller 130 may convert the display into a screen corresponding to a lower depth differently according to a distance between a first area and a second area which are formed by an inputted pinch in interaction. For example, a pinch out interaction may be inputted in a state in which the list screen corresponding to the uppermost depth is displayed. In this case, the controller 130 calculates the distance between the first area and the second area which are formed by the inputted pinch out interaction. Thereafter, the controller 130 compares the calculated distance and a predetermined first threshold distance, and, in response to the calculated distance being less than the first threshold distance, controls the display 120 to convert the currently displayed list screen into the control screen corresponding to the lower depth.

According to an exemplary embodiment, in response to the distance between the first and second areas formed by the inputted pinch out interaction being greater than or equal to the first threshold distance, the controller 130 may control the display 120 to convert the currently displayed list screen into the information providing screen corresponding to the lowermost depth.

Similarly, a pinch in interaction may be inputted in a state in which the information providing screen corresponding to the lowermost depth is displayed. In this case, the controller 130 calculates the distance between the first area and the second area which are formed by the inputted pinch in interaction. Thereafter, the controller 130 compares the calculated distance and a predetermined second threshold distance, and, in response to the calculated distance being less than the second threshold distance, controls the display 120 to convert the currently displayed information providing screen into the control screen corresponding to the upper depth. According to an exemplary embodiment, in response to the distance between the first and second areas formed by the inputted pinch in interaction being greater than or equal to the second threshold distance, the controller 130 may control the display 120 to convert the currently displayed information providing screen into the list screen corresponding to the uppermost depth.

According to another exemplary embodiment, the display 120 may display an icon for converting into a screen corresponding to an upper depth or a lower depth on the screen. Accordingly, in response to a touch input on the icon displayed on the screen being inputted or a manipulation command being inputted through a key manipulator, the controller 130 may control the display 120 to convert a currently displayed screen into a screen corresponding to the inputted touch or manipulation command.

According to additional aspects of one or more exemplary embodiments, in response to a user's touch being inputted in a state in which the list screen including contents corresponding to a plurality of pre-registered speakers is displayed, the controller 130 may set at least two contents to the same group or may negate the setting of the at least two groups to the same group.

According to an exemplary embodiment, in response to a touch of a first drag interaction being inputted by the user in a state in which the list screen including the contents corresponding to the plurality of pre-registered speakers is displayed, the controller 130 may set at least two of the plurality of contents included in the list screen to be grouped into the same group. In response to a second drag interaction being inputted in the state in which the at least two contents are set to the same group, the controller 130 may negate the setting of the at least two contents into the same group.

Specifically, the display 120 may display the list screen including first to third contents corresponding to the first to third speakers 10 to 30. The first to third speakers 10 to 30 corresponding to the first to third contents may be set to output different audios by the user. In response to a first drag interaction on the second content corresponding to the second speaker 20 being inputted in the state in which audio setting is performed for the first to third speakers 10 to 30, the controller 130 moves the second content in a direction corresponding to the first drag interaction. Thereafter, in response to the input of the first drag interaction being finished, the controller compares distances between the first and third contents and the second content which is moved by the first drag interaction. In response to the second content moved by the first drag interaction being placed within a predetermined threshold distance from the first content, the controller 130 may set the first and second contents to the same group. Accordingly, the controller 130 may reset an audio setting on the second speaker 20 such that the same audio is outputted through the first and second speakers 10, 20 corresponding to the first and second contents.

In response to a second drag interaction on the second content corresponding to the second speaker 20 being inputted in the state in which the first and second contents corresponding to the first and second speakers 10, 20 are set to the same group, the controller 130 moves the second content in a direction corresponding to the second drag interaction. Thereafter, in response to the input of the second drag interaction being finished, the controller 130 compares the distance between the first and second contents. In response to the second content moved by the second drag interaction being placed outside of the predetermined threshold distance from the first content, the controller 130 may negate the setting of the first and second contents to the same group. Accordingly, the controller 130 may reset the audio setting on the second speaker 20 such that different audios are outputted through the first and second speakers 10, 20 corresponding to the first and second contents.

In response to the second content being set to the same group as the first content in a state in which an audio is outputted through the first speaker 10 corresponding to the first content from among the plurality of contents, the controller 130 may control the communicator 140 to transmit the same audio data to the first and second speakers 10, 20 corresponding to the first and second contents. According to such a control command, the communicator 140 transmits audio reproduction information including audio data to be outputted from the first and second speakers 10, 20 to the AP apparatus 210. Accordingly, the first and second speakers 10, 20 may output the same audio based on the audio reproduction information received from the hub apparatus 220 physically connected with the AP apparatus 210.

In response to the group setting of the first and second contents being negated in the state in which the same audio is outputted from the first and second speakers 10, 20 corresponding to the first and second contents which are set to the same group, the controller 130 may control the communicator 140 to transmit different audio data to the first and second speakers 10, 20. According to such a control command, the communicator 140 transmits audio reproduction information including different audio data to be outputted from the first and second speakers 10, 20 to the AP apparatus 210. Therefore, the first and second speakers 10, 20 may output different audios based on the audio reproduction information received from the hub apparatus 220 physically connected with the AP apparatus 210.

However, the present disclosure is not limited to this. When an audio is outputted from the first speaker 10 corresponding to the first content before the first and second contents are set to the same group, in response to the setting of the first and second contents to the same group being negated, the controller 130 may control the communicator 140 to transmit audio data on the corresponding audio to the speaker 10 corresponding to the first content. According to such a control command, the communicator 140 transmits audio reproduction information including the audio data to be outputted from the first speaker 10 to the AP apparatus 210. Accordingly, the first speaker 10 may output the audio based on the audio reproduction information received from the hub apparatus 220 physically connected with the AP apparatus 210.

According to an exemplary embodiment, the communicator 140 may be implemented by using a short-distance communication module including at least one of a Wi-Fi direct communication module, a Bluetooth module, an Infrared Data Association (IrDA) module, a Near Field Communication (NFC) module, and a Zigbee module, etc. However, the present disclosure is not limited to this. The communicator 140 may be implemented by using a long-distance communication module including at least one of a cellular communication module, a 3rd generation (3G) mobile communication module, a 4th generation (4G) mobile communication module, and a 4G Long Term Evolution (LTE) communication module, etc.

In response to the same audio or different audios being outputted from the first and second speakers 10, 20 corresponding to the first and second contents from among the plurality of contents, the controller 130 may control the display 120 to display the first and second contents and the other contents differently. Accordingly, the display 120 may display the first and second contents which output current audio from among the plurality of contents, and the other contents which do not output an audio differently. According to an exemplary embodiment, the display 120 may add a vibration waveform around the first and second contents which output current audio from among the plurality of contents, and display the first and second contents. Therefore, the user may determine audio output states of the plurality of speakers based on the content to which the vibration waveform is added from among the plurality of contents displayed on the screen of the display apparatus 100.

According to an exemplary embodiment, in response to an audio application being executed, the plurality of screens having the hierarchical structure may further include a speaker list for controlling the plurality of pre-registered speakers as described above. The plurality of speakers included in the speaker list may be speakers which are able to perform data communication with the display apparatus via the AP apparatus 210 on the same network. Therefore, the controller 130 may perform audio setting on at least one of the plurality of speakers included in the speaker list according to a user command inputted through the inputter 110. The audio setting recited herein may include at least one of controlling a volume and reproduction (on/off timer) of an audio to be outputted through each speaker, and editing a name of each speaker.

Hereinafter, an operation of converting a currently displayed screen into a screen corresponding to an upper depth or a lower depth according to a pinch interaction in an exemplary display apparatus 100 will be explained in detail.

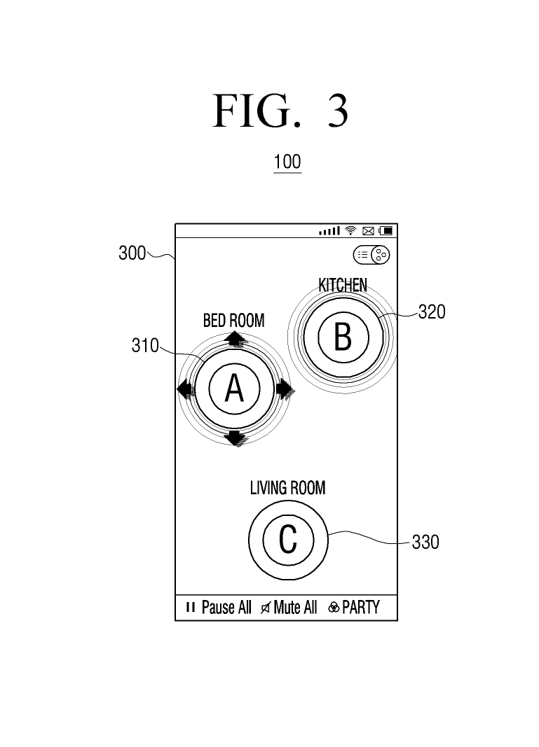

FIG. 3 is a view illustrating an example of a list screen which provides a content list in the display apparatus according to an exemplary embodiment.

As shown in FIG. 3, in response to an audio application being executed, the display apparatus 100 may display a list screen 300 corresponding to an uppermost depth. The list screen 300 recited herein may be a screen which provides a content list including first to third contents 310 to 330 corresponding to a plurality of speakers (hereinafter, referred to as first to third speakers) 10 to 30 pre-registered in the display apparatus 100. In addition, the first to third speakers 10 to 30 perform audio reproduction-related operations according to a control command of the display apparatus 100 on the same network as the display apparatus 100, and the first to third contents 310 to 330 may be objects corresponding to the pre-registered first to third speakers 10 to 30 to identify the first to third speakers 10 to 30.

For example, the first to third contents 310 to 330 corresponding to the first to third speakers 10 to 30 may be implemented by using a bubble-shaped image, and may display audio information on audios to be outputted from the first to third speakers 10 to 30 on the center thereof. Identification information may be displayed around the first to third contents 310 to 330 to identify the first to third speakers 10 to 30. In addition, visual effect images may be displayed around the first to third contents 310 to 330 to visually show whether audios are outputted through the first to third speakers 10 to 30.

For example, the user may set an ‘A’ audio to be outputted from the first speaker 10, set a ‘B’ audio to be outputted from the second speaker 20, and set a ‘C’ audio to be outputted from the third speaker 30, and may control audios to be outputted through the first and second speakers 10, 20. In addition, the user may set the first speaker 10 located in a bed room to TED ROOM′, set the second speaker 20 located in a kitchen to ‘KITCHEN’, and set the third speaker 30 located in a living room to ‘LIVING ROOM’ in order to keep track of where the first to third speakers 10 to 30 are located.

In this case, the first content 310 may display audio information on the ‘A’ audio set to be outputted from the first speaker 10 in the center thereof, the second content 320 may display audio information on the ‘B’ audio set to be outputted from the second speaker 20 in the center thereof, and the third content 330 may display audio information on the ‘C’ audio set to be outputted from the third speaker 30 in the center thereof. In addition, visual effect images may be displayed around the first and second contents 310, 320 corresponding to the first and second speakers 10, 20, which currently output the audio according to a user command, in order to show that the audios are outputted from the first and second speakers 10, 20. For example, as illustrated in FIG. 3, concentric circles may be displayed around the contents to indicate that audio is being outputted. In addition, identification information of the first to third speakers 10 to 30, which are set by the user, may be displayed around the first to third contents 310 to 330. Accordingly, the user may identify which audio is set for the first to third speakers 10 to 30 and where the first to third speakers 10 to 30 are located through the first to third contents 310 to 330 displayed on the list screen 300, and may identify that the first and second speakers 10, 20 from among the first to third speakers 10 to 30 currently output audios through the first to third contents 310 to 330.

In addition, the first to third contents 310 to 330 displayed on the list screen 300 may be moved vertically and horizontally within a predetermined range. As the first to third contents 310 to 330 are moved vertically and horizontally within the predetermined range, the user can recognize movement of the first to third contents 310 to 330 on the list screen 300.

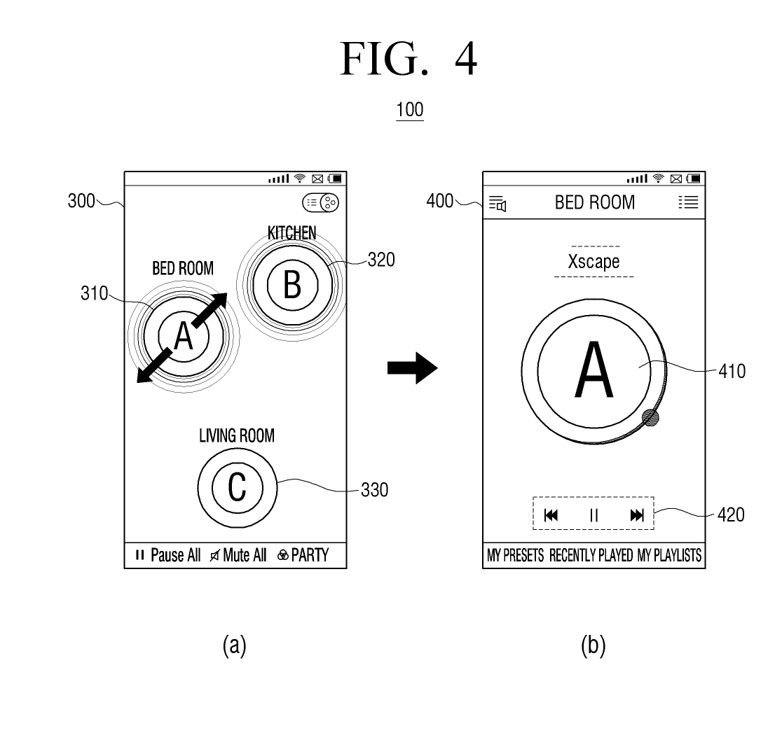

FIG. 4 is a view illustrating an example of converting into a screen corresponding to a lower depth according to a pinch out interaction in the display apparatus according to an exemplary embodiment.

As shown in view (a) of FIG. 4, in response to an audio application being executed, the display apparatus 100 may display the list screen 300 corresponding to the uppermost depth. The list screen 300 may be a screen which provides the content list on the first to third contents 310 to 330 corresponding to the first to third speakers 10 to 30.

In the state in which the list screen 300 including the first to third contents 310 to 330 is displayed, the user may perform a touch related to a pinch out interaction on an area in which the first content 310 is displayed. In response to the pinch out interaction on the first content 310 being inputted, the display apparatus 100 may convert the currently displayed list screen 300 into a control screen 400 corresponding to a lower depth, and display the control screen 400, as shown in view (b) of FIG. 4. That is, the display apparatus 100 may display the control screen 400 including audio information 410 on the ‘A’ audio which is being outputted through the first speaker 10, and a control User Interface (UI) 420 to control audio output of the first speaker 10.

In response to the control screen 400 for controlling the first speaker 10 being displayed, the user may perform audio setting on the ‘A’ audio, which is being reproduced in the first speaker 10, through the control UI 420 displayed on the control screen 400. In response to such an audio setting command being inputted, the display apparatus 100 transmits audio reproduction information including identification information on the first speaker 10 and the audio setting command to the AP apparatus 210. Accordingly, the first speaker 10 may control output of the ‘A’ audio based on the audio reproduction information received from the hub apparatus 220 physically connected with the AP apparatus 210.

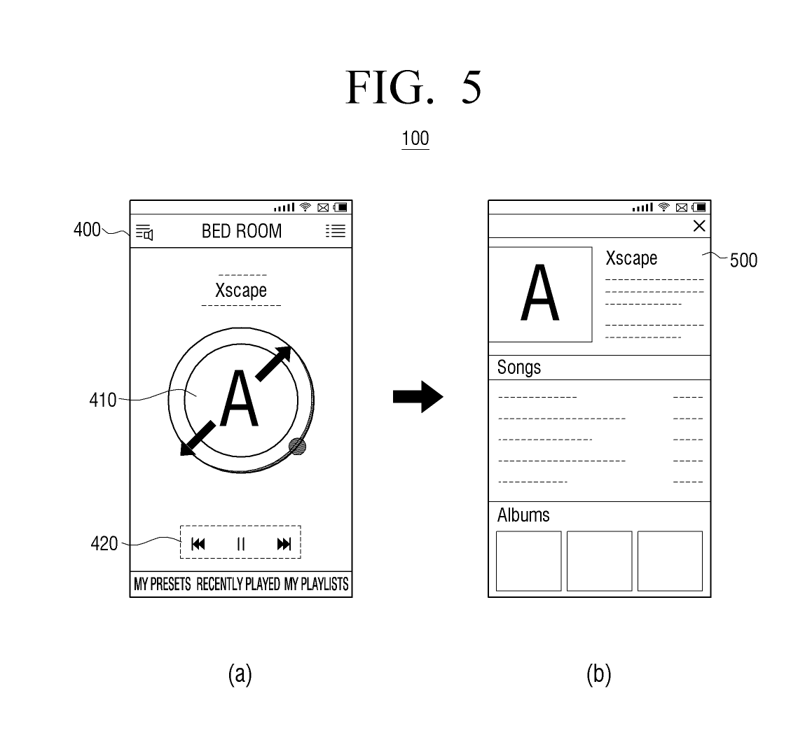

FIG. 5 is a view illustrating an example of converting into a screen corresponding to a lower depth according to a pinch out interaction in the display apparatus according to an exemplary embodiment.

As shown in view (a) of FIG. 5, in the state in which the audio application is executed, the display apparatus 100 may display the control screen 400 for controlling the first speaker 10. Herein, the control screen 400 is a screen for controlling the first speaker 10 from among the pre-registered first to third speakers 10 to 30, and has been described in FIG. 4 in detail and thus a detailed description thereof is omitted here.

In response to the control screen 400 for controlling the first speaker 10 being displayed, the user may perform a touch related to a pinch out interaction on an area in which the control screen 400 is displayed. In response to such a pinch out interaction being inputted, the display apparatus 100 may convert the currently displayed control screen 400 into an information providing screen 500 corresponding to a lowermost depth, and display detailed information on the ‘A’ audio outputted from the first speaker 10, as shown in view (b) of FIG. 5. That is, in response to the pinch out interaction being inputted in the state in which the control screen 400 is displayed, the display apparatus 100 may receive detailed information on the ‘A’ audio outputted from the first speaker 10 from an external server or a storage, and display the detailed information. However, the present disclosure is not limited to this. In response to the detailed information on the ‘A’ audio outputted from the first speaker 10 being pre-stored and the pinch out interaction being inputted in the state in which the control screen 400 is displayed, the display apparatus 100 may extract the detailed information on the ‘A’ audio and display the detailed information on the screen.

According to an exemplary embodiment, in response to the detailed information on the ‘A’ audio outputted from the first speaker 10 not being received from an external server, or the detailed information on the ‘A’ audio outputted from the first speaker 10 not being stored, the display apparatus 100 may display an audio reproduction list related to already outputted audios in relation to the ‘A’ audio outputted from the first speaker 10 based on pre-stored audio history information. The audio history information, which is history information about already reproduced audios, may include reproduction date information, composer information, album information, singer information on the already reproduced audios, or the like. Therefore, the display apparatus 100 may generate an audio list including at least one audio to be recommended to the user with reference to the audio history information pre-stored in relation to the ‘A’ audio, and display the audio list.

Accordingly, the user may select an audio that the user wants to listen to through the displayed audio list, and, in response to such an audio selection command being inputted, the display apparatus 100 transmits audio reproduction information including audio data corresponding to the audio selection command and identification information on the first speaker 10 to the AP apparatus 210. Then, the first speaker 10 may output the audio selected by the user based on the audio reproduction information received from the hub apparatus 220 physically connected with the AP apparatus 210.

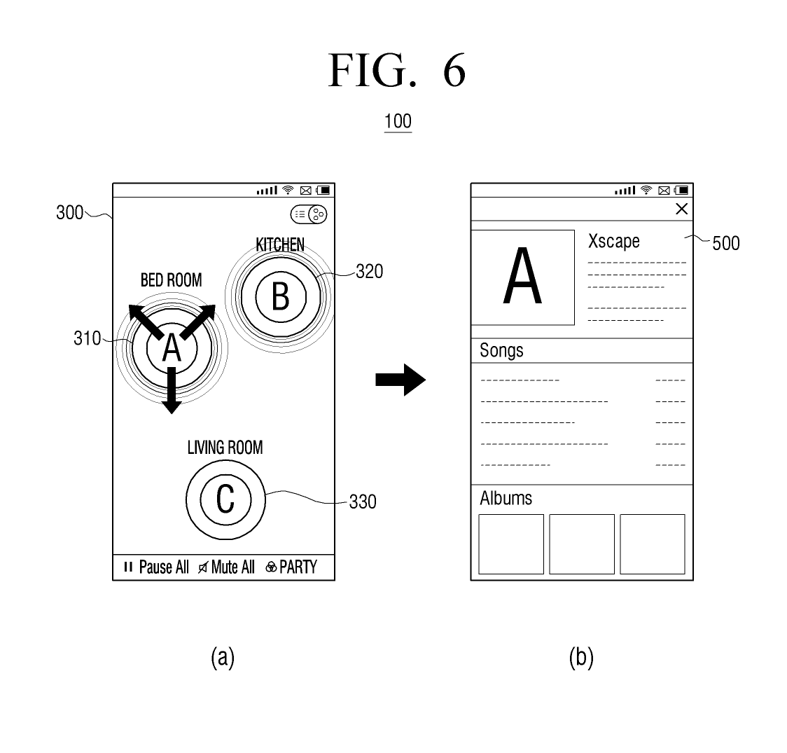

FIG. 6 is a view illustrating an example of converting into a screen corresponding to a lowermost depth according to a three-finger pinch out interaction in the display apparatus according to an exemplary embodiment.

As shown in view (a) of FIG. 6, in response to an audio application being executed, the display apparatus 100 may display the list screen 300 corresponding to the uppermost depth. The list screen 300 may be a screen which provides the content list on the first to third contents 310 to 330 corresponding to the first to third speakers 10 to 30, and has been described in FIG. 3 in detail and thus a detailed description is omitted here.

In the state in which the list screen 300 including the first to third contents 310 to 330 is displayed, the user may perform a touch related to a three-finger pinch out interaction on an area on which the first content 310 is displayed. In response to the three-finger pinch out interaction on the first content 310 being inputted, the display apparatus 100 may convert into the information providing screen 500 for providing detailed information on the ‘A’ audio outputted from the first speaker 10 corresponding to the first content 310, as shown in view (b) of FIG. 6. In other words, in response to the three-finger pinch out interaction, the display is converted directly from the uppermost depth into the lowermost depth. Therefore, the three-finger pinch out interaction may be used as a shortcut to skip over the middle depth display screen.

In response to the three-finger pinch out interaction being inputted in the state in which the list screen 300 corresponding to the uppermost depth is displayed, the display apparatus 100 may receive detailed information on the ‘A’ audio outputted from the first speaker 10 from an external server, and display the detailed information. However, the present disclosure is not limited to this. For example, in response to the detailed information on the ‘A’ audio outputted from the first speaker 10 being pre-stored and the three-finger pinch out interaction being inputted in the state in which the list screen 300 is displayed, the display apparatus 100 may extract the detailed information on the ‘A’ audio and display the detailed information on the screen.

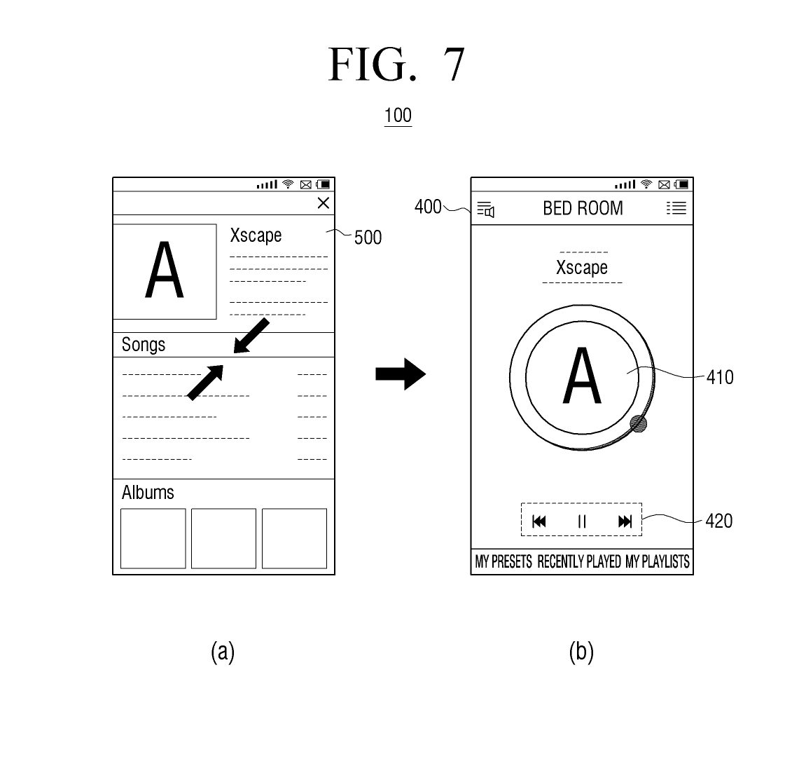

FIG. 7 is a view illustrating an example of converting into a screen corresponding to an upper depth according to a pinch in interaction in the display apparatus according to an exemplary embodiment.

As shown in view (a) of FIG. 7, in the state in which an audio application is executed, the display apparatus 100 may display the information providing screen 500 corresponding to the lowermost depth. The information providing screen 500 is a screen which provides detailed information about an audio outputted through a speaker corresponding to a content selected by the user from the first to third contents 310 to 330 corresponding to pre-registered first to third speakers 10 to 30. As shown in view (a) of FIG. 7, the display apparatus 100 may display the information providing screen 500 which provides detailed information on the ‘A’ audio outputted through the first speaker 10 corresponding to the first content 310 selected by the user.

In the state in which the information providing screen 500 providing the detailed information on the ‘A’ audio outputted through the first speaker 10 is displayed, the user may perform a touch related to a pinch in interaction on the information providing screen 500. In response to the pinch in interaction being inputted, the display apparatus 100 may convert the currently displayed information providing screen 500 into the control screen 400 corresponding to the upper depth and display the control screen 400, as shown in view (b) of FIG. 7. That is, the display apparatus 100 may display the control screen 400 including the audio information 410 on the ‘A’ audio which is being outputted through the first speaker 10 and the control UI 420 for controlling the audio output of the first speaker 10.

In response to the control screen 400 for controlling the first speaker 10 being displayed, the user may perform audio setting on the ‘A’ audio, which is being reproduced in the first speaker 10, through the control UI 420 displayed on the control screen 400.

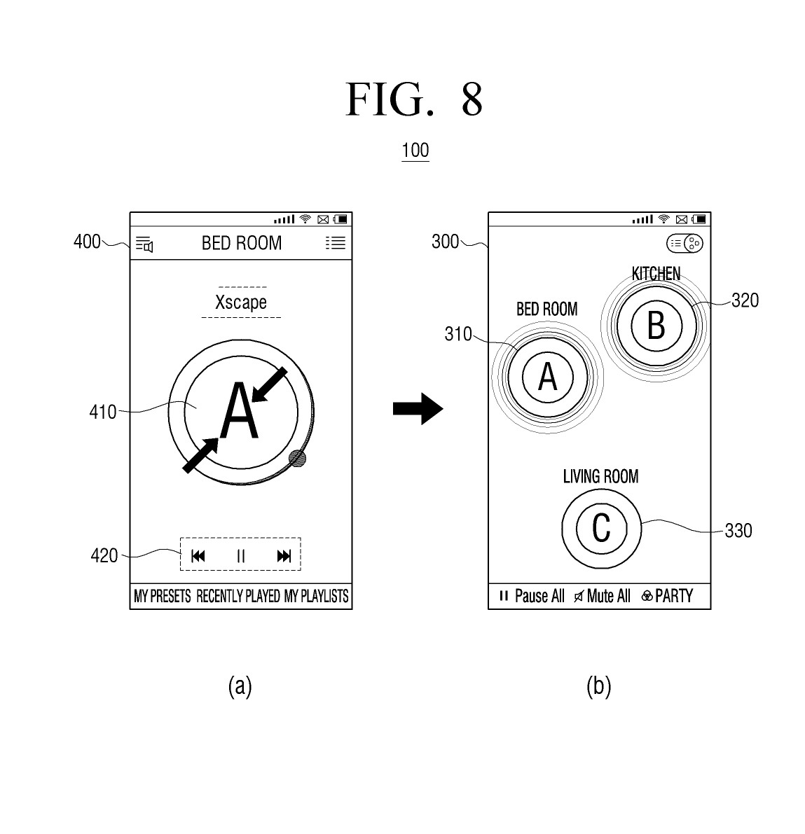

FIG. 8 is a view illustrating an example of converting into a screen corresponding to an uppermost depth according to a pinch in interaction in the display apparatus according to an exemplary embodiment.

As shown in view (a) of FIG. 8, in the state in which an audio application is executed, the display apparatus 100 may display the control screen 400 for controlling the first speaker 10. The control screen 400 may be a screen for controlling a speaker corresponding to a content selected by the user from among the pre-registered first to third speakers 10 to 30. As shown in view (a) of FIG. 8, the display apparatus 100 may display the control screen 400 for controlling the first speaker 10 corresponding to the first content 310 selected by the user.

In the state in which the control screen 400 for controlling the first speaker 10 is displayed, the user may perform a touch related to a pinch in interaction on the area on which the control screen 400 is displayed. In response to the pinch in interaction being inputted, the display apparatus 100 may convert the currently displayed control screen 400 into the list screen 300 including the first to third contents 310 to 330 corresponding to the pre-registered first to third speakers 10 to 30, and display the list screen 300, as shown in view (b) of FIG. 8. Accordingly, the user may grasp which speaker currently outputs an audio and where each speaker is located through the first to third contents 310 to 330 included in the list screen 300.

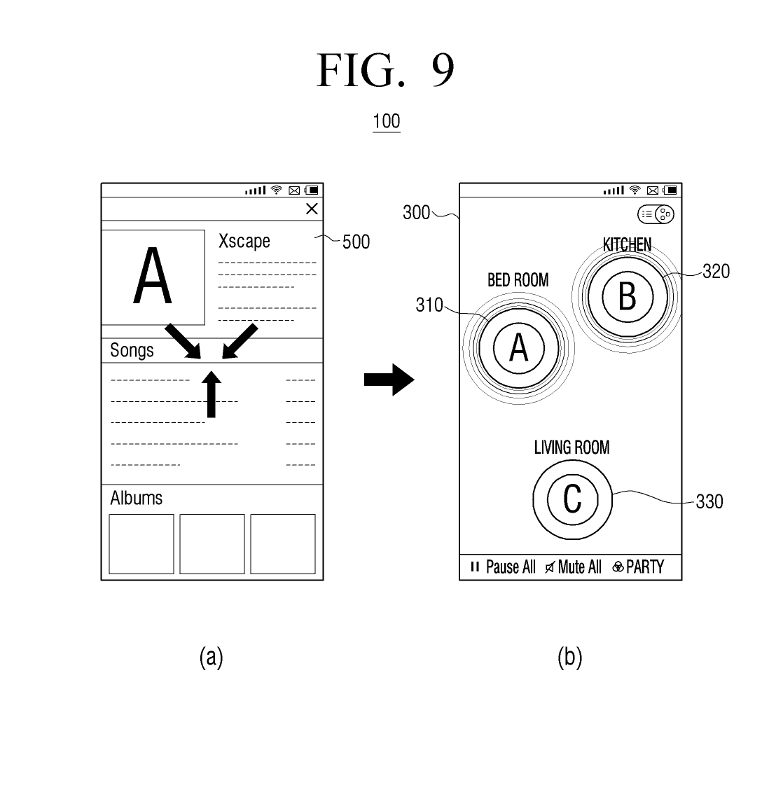

FIG. 9 is a view illustrating an example of converting into a screen corresponding to an uppermost depth according to a three-finger pinch in interaction in the display apparatus according to an exemplary embodiment.

As shown in view (a) of FIG. 9, in the state in which an audio application is executed, the display apparatus 100 may display the information providing screen 500 corresponding to the lowermost depth. The information providing screen 500 is a screen which provides detailed information on an audio outputted through a speaker corresponding to a content selected by the user from the first to third contents 310 to 330 corresponding to pre-registered first to third speakers 10 to 30. As shown in view (a) of FIG. 9, the display apparatus 100 may display the information providing screen 500 which provides detailed information on the ‘A’ audio outputted through the first speaker 10 corresponding to the first content 310 selected by the user.

In the state in which the information providing screen 500 providing the detailed information on the ‘A’ audio outputted through the first speaker 10 is displayed, the user may perform a touch related to a three-finger pinch in interaction on the information providing screen 500. In response to the three-finger pinch in interaction being inputted, the display apparatus 100 may convert the currently displayed information providing screen 500 into the list screen 300 corresponding to the uppermost depth and display the list screen 300, as shown in view (b) of FIG. 9. In other words, in response to the three-finger pinch in interaction, the display is converted directly from the lowermost depth into the uppermost depth. Therefore, the three-finger pinch in interaction may be used as a shortcut to skip over the middle depth display screen.

Accordingly, the display apparatus 100 may display the content list including the first to third contents 310 to 330 corresponding to the pre-registered first to third speakers 10 to 30 through the list screen 300 corresponding to the uppermost depth. Accordingly, the user may grasp which speaker currently outputs an audio and where each speaker is located through the first to third contents 310 to 330 included in the list screen 300.

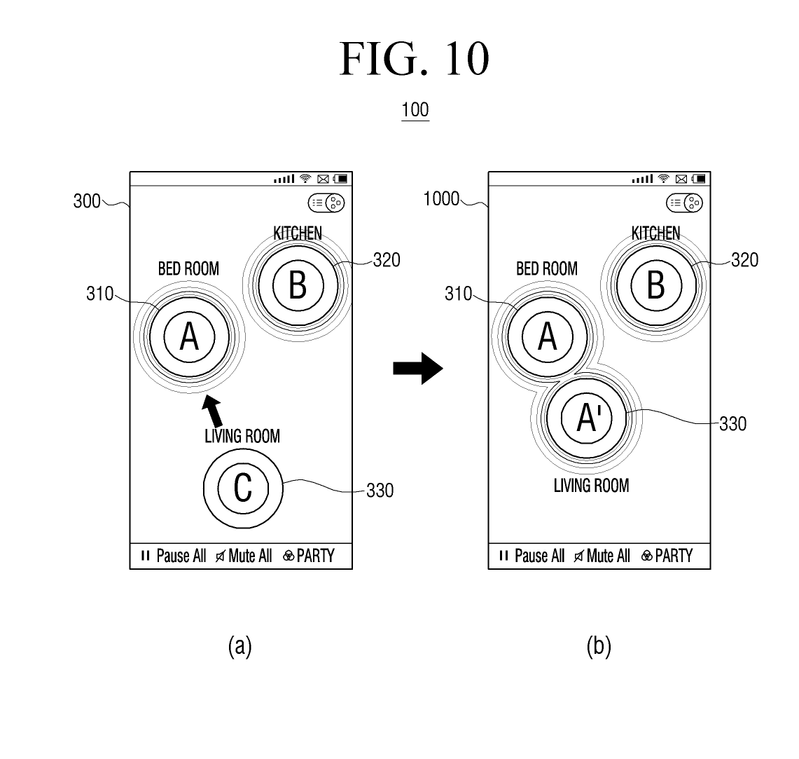

FIG. 10 is a view illustrating an example of setting multiple speakers and/or contents to the same group according to a drag interaction in the display apparatus according to an exemplary embodiment.

As shown in view (a) of FIG. 10, in response to an audio application being executed, the display apparatus 100 may display the list screen 300 corresponding to the uppermost depth. The list screen 300 may be a screen which provides the content list on the first to third contents 310 to 330 corresponding to the first to third speakers 10 to 30.

In the state in which the list screen 300 including the first to third contents 310 to 330 is displayed, the user may perform a drag touch related to a drag interaction from an area in which the third content 330 is displayed to an area in which the first content 310 is displayed. In response to the drag interaction on the third content 330 being inputted, the display apparatus 100 may move the third content 330. In response to the drag interaction on the third content 330 being finished, the display apparatus 100 compares a distance between the third content 330 moved by the drag interaction and the first content 310, and a distance between the third content 330 moved by the drag interaction and the second content 320. In response to the distance between the third content 330 moved by the drag interaction and the first content 310 falling within a predetermined threshold distance, the display apparatus 100 sets the first and third contents 310, 330 to the same group as shown in view (b) of FIG. 10.

That is, the display apparatus 100 re-performs audio setting on the third speaker 30 corresponding to the third content 330 by changing from a ‘C’ audio pre-set in the third speaker 30 corresponding to the third content 330 to the ‘A’ audio pre-set in the first speaker 10 corresponding to the first content 310.

That is, the display apparatus 100 re-sets the audio pre-set in the third speaker 30 corresponding to the third content 330 based on audio setting information on the ‘A’ audio pre-set in the first speaker 10 corresponding to the first content 310. Accordingly, the third speaker 30 corresponding to the third content 330 may be re-set from the pre-set ‘C’ audio to the ‘A’ audio pre-set in the first speaker 10.

In response to the third speaker 30 corresponding to the third content 330 being re-set to the ‘A’ audio pre-set in the first speaker 10 as described above, audio information on the ‘A′’ audio which is re-set to be outputted as the same audio as that of the first speaker 30 may be displayed in the center of the third content 330. Meanwhile, the first and second speakers from among the first to third speakers 10 to 30 corresponding to the first to third contents 310 to 330 may output the ‘A’ audio and the ‘B’ audio, respectively, according to a user command. In this case, in response to the first and third contents 310 and 330 being set to the same group, the display apparatus 100 transmits audio reproduction information on the ‘A’ audio to the AP apparatus 210 such that the first and third speakers 10, 30 corresponding to the first and third contents 310, 330 output the ‘A’ audio. Accordingly, the first and third speakers 10, 30 may output the same audio based on the audio reproduction information received from the hub apparatus 220 physically connected with the AP apparatus 210.

In response to the same ‘A’ audio being outputted through the first and third speakers 10, 30 corresponding to the first and third contents 310, 330 which are set to the same group as described above, the display apparatus 100 may display visual effect images around the first and third contents 310, 330 to indicate that audios are outputted from the first and third speakers 10, 30. Therefore, the user can recognize that the same ‘A’ audio is outputted through the first and third speakers 10, 30 corresponding to the first and third contents 310, 330.

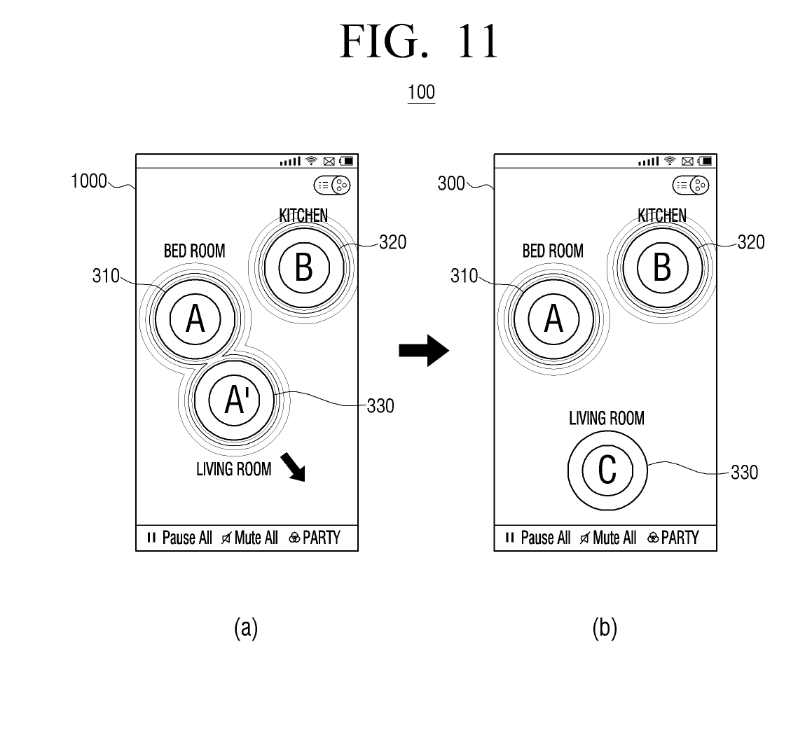

FIG. 11 is a view illustrating an example of negating a group setting to the same group according to a drag interaction in the display apparatus according to an exemplary embodiment.

In the state in which the first and third contents 310, 330 are set to the same group as explained in view (b) of FIG. 10, a drag interaction on the third content 330 may be inputted in the opposite direction to the area on which the first content 310 is displayed. In response to such a drag interaction on the third content 330 being inputted, the display apparatus 100 may move the third content 330. In response to the drag interaction on the third content 330 being finished, the display apparatus 100 compares a distance between the third content 330 moved by the drag interaction and the first content 310. In response to the distance between the third content 330 moved by the drag interaction and the first content 310 falling out of the predetermined threshold distance, the display apparatus 100 may ungroup the first and third contents 310, 330 which have been set to the same group, as shown in view (b) of FIG. 11.

In this example, the display apparatus 100 may re-set the audio to the ‘C’ audio pre-set in the third speaker 30 corresponding to the third content 330 before the third content 330 was set to the same group with the first content 310. Therefore, the ‘A’ audio and the ‘B’ audio may be outputted through the first and second speakers 10, 20 except for the third speaker 30 from among the first to third speakers 10 to 30 corresponding to the first to third contents 310 to 330.

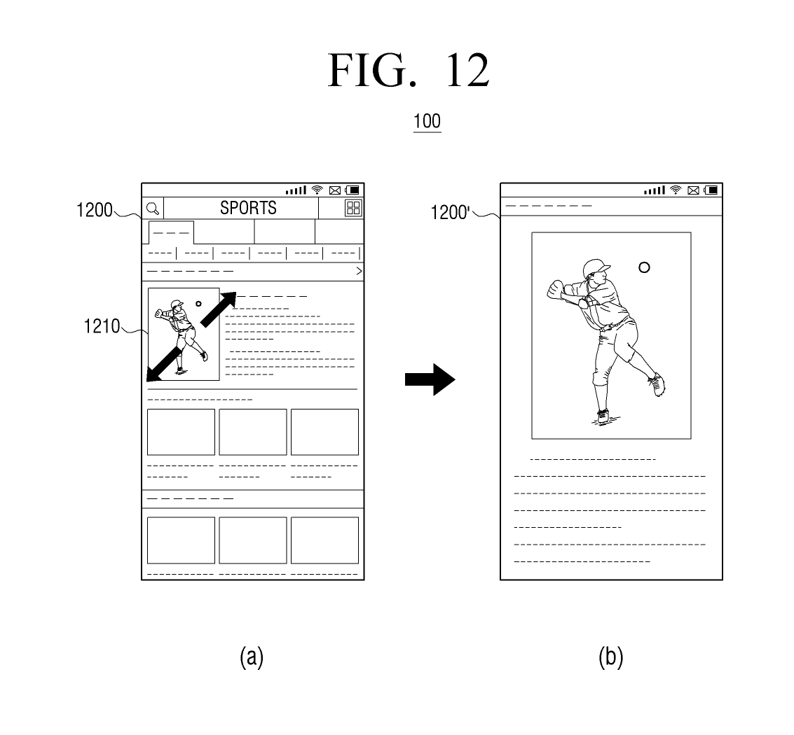

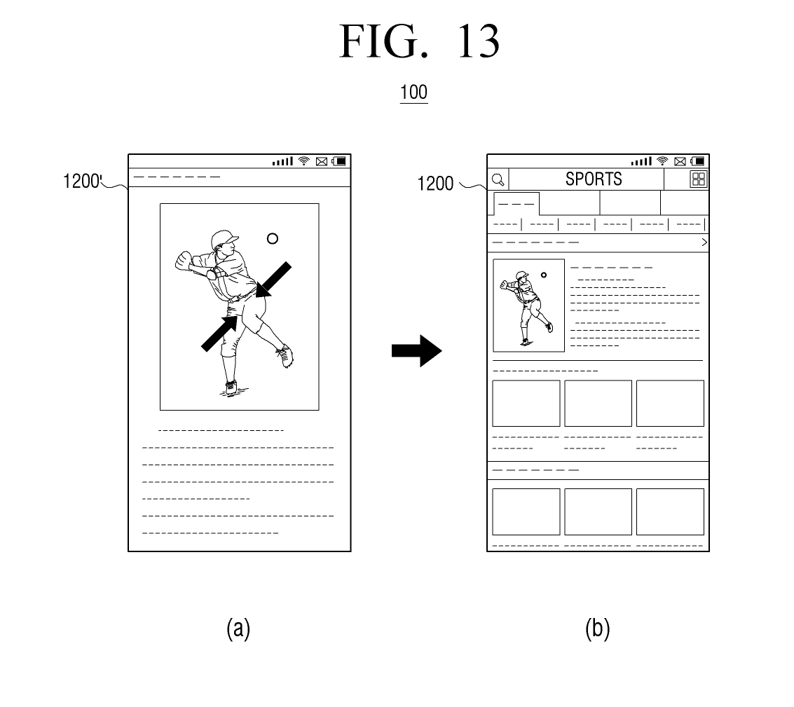

FIG. 12 is a view illustrating an example of converting into a webpage screen corresponding to a lower depth according to a pinch out interaction in the display apparatus according to an exemplary embodiment, and FIG. 13 is a view illustrating an example of converting into a webpage screen corresponding to an upper depth according to a pinch in interaction in the display apparatus according to an exemplary embodiment.

As shown in view (a) of FIG. 12, the display apparatus 100 may display a webpage screen 1200 which is provided by a web server according to a user request. The webpage screen 1200 may be a main screen of a web site corresponding to an upper depth. In response to the webpage screen 1200 being displayed, the user may input a touch for a pinch out interaction on an area on which one of a plurality of objects included in the webpage screen 1200 is displayed. In response to the pinch out interaction on the specific object being inputted, the display apparatus 100 may convert the currently displayed web page screen 1200 to an information providing screen 1200′ corresponding to a lower depth, and display the information providing screen 1200′.

For example, the user may input the touch for the pinch out interaction on an area on which a first object 1210 from among the plurality of objects included in the webpage screen 1200 is displayed. In this case, the display apparatus 100 may convert the currently displayed webpage screen 1200 to the information providing screen 1200′ which provides detailed information about the first object, and display the information providing screen 1200′ as shown in view (b) of FIG. 12.

According to an exemplary embodiment, in the state in which the information providing screen 1200′ providing the detailed information on the first object is displayed as shown in view (a) of FIG. 13, a pinch in interaction may be inputted. In response to such a pinch in interaction being inputted, the display apparatus 100 may convert the information providing screen 1200′ providing the detailed information on the first object to the webpage screen 1200 which is the main screen of the web site, and display the information providing screen 1200′ as shown in view (b) of FIG. 13.

As described above, the display apparatus 100 converts into the webpage screen corresponding to the upper depth or lower depth according to the user interaction, so that the user can convert a screen on a web page without using a screen conversion icon displayed on the screen of the display apparatus 100.

Hereinafter, an operation of controlling at least one of the first to third speakers 10 to 30 pre-registered in the speaker list in the display apparatus 100 according to one or more exemplary embodiments will be explained.

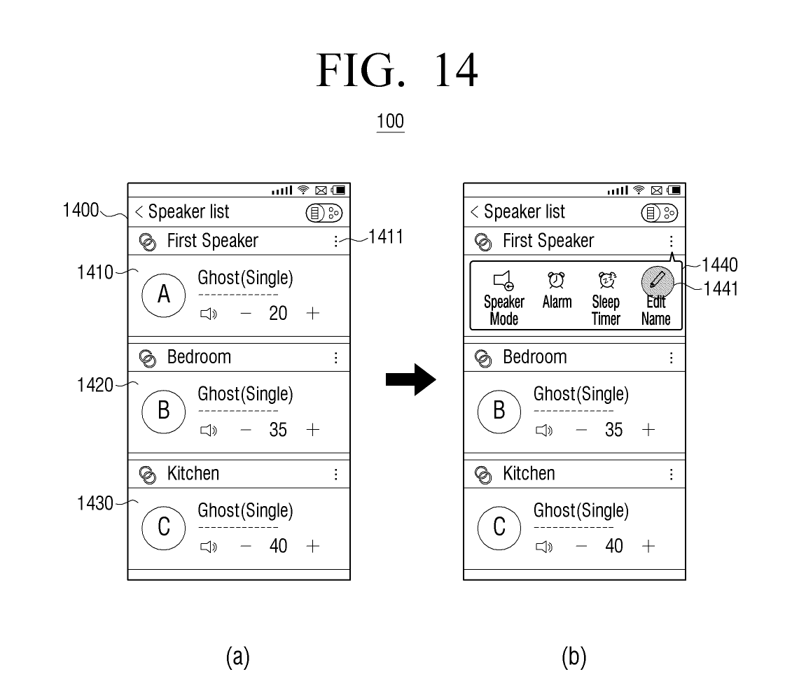

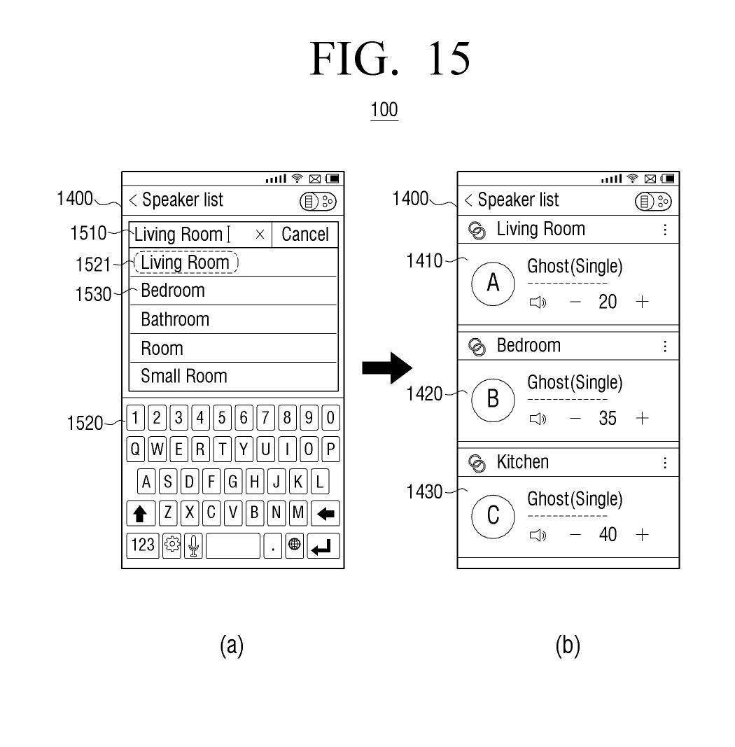

FIG. 14 is a view illustrating an example of setting speakers pre-registered in the display apparatus according to an exemplary embodiment, and FIG. 15 is a view illustrating an example of a speaker list in which speaker setting for speakers pre-registered in the display apparatus is completed according to an exemplary embodiment.

As shown in view (a) of FIG. 14, in the state in which an audio application is executed, the display apparatus 100 may display a speaker list screen 1400 including pre-registered first to third speakers 1410 to 1430 according to a user command. The speaker list screen 1400 may be a screen for audio setting for each of the first to third speakers 1410 to 1430 pre-registered in the display apparatus 100.

As shown in FIG. 14, the second and third speakers 1420, 1430 except for the first speaker 1410 from among the first to third speakers 1410 to 1430 may be set to have speaker names ‘Bedroom’ and ‘Kitchen,’ respectively. In this example, a speaker name ‘first speaker’ which is pre-defined may be displayed on an object on the first speaker 1410 displayed on the speaker list screen 1400, and speaker names ‘Bedroom’ and ‘Kitchen,’ which are re-set by the user, may be displayed on objects corresponding to the second and third speakers 1420, 1430. It should be understood that the inventive concepts are not limited to this configuration.

In the state in which the speaker list screen 1400 including the objects corresponding to the first to third speakers 1410 to 1430 is displayed, in response to an editing icon 1411 displayed on the object corresponding to the first speaker 1410 being selected, the display apparatus 100 may display an editing menu window 1440 on the object corresponding to the first speaker 1410 as shown in view (b) of FIG. 14.

However, the present disclosure is not limited to this. For example, in response to a pinch out interaction on the object corresponding to the first speaker 1410 being inputted, the display apparatus 100 may display the editing menu window 1440 on the object corresponding to the first speaker 1410. The editing menu window 1440 may include at least one of a speaker mode icon for setting an audio output mode of the first speaker 1410, an alarm icon for setting an audio reproduction time, a sleep timer icon for setting an audio reproduction end time, and an editing icon for editing a speaker name of the first speaker 1410.

In response to the editing icon 1441 for editing the speaker name of the first speaker 1410 being selected from the plurality of icons or a pinch out interaction on an area on which the editing icon 1441 is displayed being inputted, the display apparatus 100 may display a text window 1510 which displays an inputted text in relation to the speaker name of the first speaker 1410, and a keyboard UI 1520 for inputting a text, as shown in view (a) of FIG. 15. In this example, in response to pre-defined speaker names being stored, the display apparatus 100 may additionally display a speaker name list window 1530 including the pre-stored speaker names. Therefore, the user may input a text corresponding to the speaker name of the first speaker 1410 through the keyboard UI 1520, or may select one of the plurality of speaker names displayed on the speaker name list window 1530.

In response to such a text being inputted or a speaker name being selected, the display apparatus 100 may display the text inputted through the keyboard UI 1520 in the text window 1510 or may display the text corresponding to the speaker name selected from the speaker name list window 1530 in the text window 1510. For example, in response to a first speaker name 1521 “Living Room” being selected from the plurality of speaker names displayed on the speaker name list window 1530, the display apparatus 100 may display the text “Living Room” in the text window 1510.

Thereafter, in response to a selection command on the text “Living Room” displayed on the text window 1510 being inputted, the display apparatus 100 may convert the speaker name on the object corresponding to the first speaker 10 into the speaker name “Living Room,” and display the speaker name “Living Room,” as shown in view (b) of FIG. 15. Accordingly, the user can easily identify where the first speaker 1410 is placed through the speaker name displayed on the object corresponding to the first speaker 1410.

Hereinafter, a method for controlling the speakers according to a user interaction in the display apparatus 100 according to an exemplary embodiment will be explained.

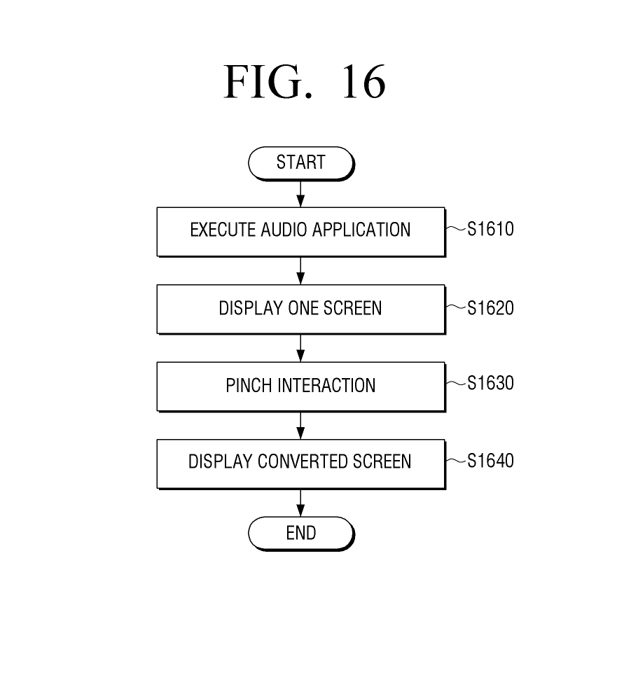

FIG. 16 is a flowchart illustrating a method for controlling according to a user interaction in the display apparatus according to an exemplary embodiment.

As shown in FIG. 16, the display apparatus 100 executes an application corresponding to a user command and displays an execution screen corresponding to the executed application (S1610, S1620). The displayed execution screen may be one of a plurality of screens having a hierarchical structure. According to an exemplary embodiment, when the executed application is an audio application, the plurality of screens having the hierarchical structure may include at least one of a list screen, a control screen, and an information providing screen. The list screen may be a screen which provides a content list including contents (hereinafter, referred to as first to third contents) corresponding to a plurality of pre-registered speakers (hereinafter, referred to as first to third speakers) 10 to 30. In addition, the control screen may be a screen for controlling audio reproduction of a speaker corresponding to a content selected from the first to third contents included in the content list. Also, the information providing screen may be a screen which provides information related to an audio outputted through the speaker corresponding to the content selected from the first to third contents.

Therefore, in response to the audio application being executed, the display apparatus 100 may display one of the plurality of screens related to the executed audio application. In response to a pinch interaction being inputted in the state in which one of the plurality of screens is displayed, the display apparatus 100 converts the currently displayed screen into a screen corresponding to an upper depth or a lower depth, and displays the converted screen (S1630, S1640).

Hereinafter, a method for converting a currently displayed screen into a screen corresponding to an upper depth or a lower depth according to a pinch interaction in the display apparatus 100, and displaying the converted screen according to an exemplary embodiment will be explained in detail.

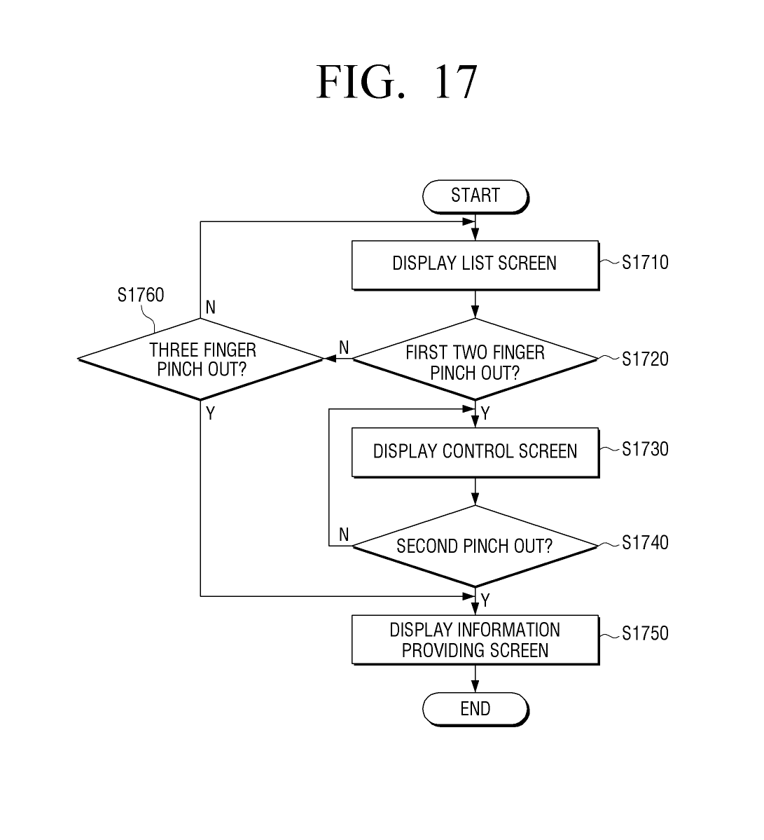

FIG. 17 is a flowchart illustrating a method for converting into a screen corresponding to a lower depth according to a pinch out interaction in the display apparatus according to an exemplary embodiment.

As shown in FIG. 17, in response to an audio application being executed according to a user command, the display apparatus 100 may display a list screen corresponding to an uppermost depth (S1710). The list screen may be a screen which provides a content list including first to third contents corresponding to pre-registered first to third speakers 10 to 30 as described above.

In response to a first pinch out interaction being inputted in the state in which the list screen is displayed, the display apparatus 100 may convert the currently displayed list screen into a control screen corresponding to a lower depth, and display the control screen (S1720, S1730). The control screen may be a screen for controlling a speaker corresponding to a content selected from the first to third contents included in the content list. In response to a second pinch out interaction being inputted in the state in which the control screen is displayed, the display apparatus 100 may convert the currently displayed control screen into an information providing screen corresponding to the lowermost depth, and display the information providing screen (S1740, S1750). The information providing screen may be a screen which provides information about an audio outputted through the speaker corresponding to the content selected from the first to third contents.

For example, in response to the first pinch out interaction being inputted on an area on which the first content from among the first to third contents is displayed, the display apparatus 100 may convert the currently displayed list screen into the control screen for controlling the first speaker corresponding to the first content, and display the control screen. In response to the second pinch out interaction being inputted in the state in which the control screen for controlling the first speaker is displayed, the display apparatus 100 may receive detailed information on the audio outputted through the first speaker from an external server, and display the detailed information on the information providing screen. However, the present disclosure is not limited to this. In response to the detailed information on the audio outputted through the first speaker being pre-stored, the display apparatus 100 may acquire the pre-stored detailed information on the audio and display the detailed information on the information providing screen.

In response to the user interaction inputted by the user being a three-finger pinch out interaction in operation 1720, the display apparatus 100 may convert the list screen corresponding to the uppermost depth into the information providing screen corresponding to the lowermost depth, and display the information providing screen (S1760). That is, in response to the three-finger pinch out interaction being inputted, the display apparatus 100 may omit the step of displaying the control screen which corresponds to a separate intermediate depth, and directly convert the list screen corresponding to the uppermost depth into the information providing screen corresponding to the lowermost depth, and display the information providing screen.

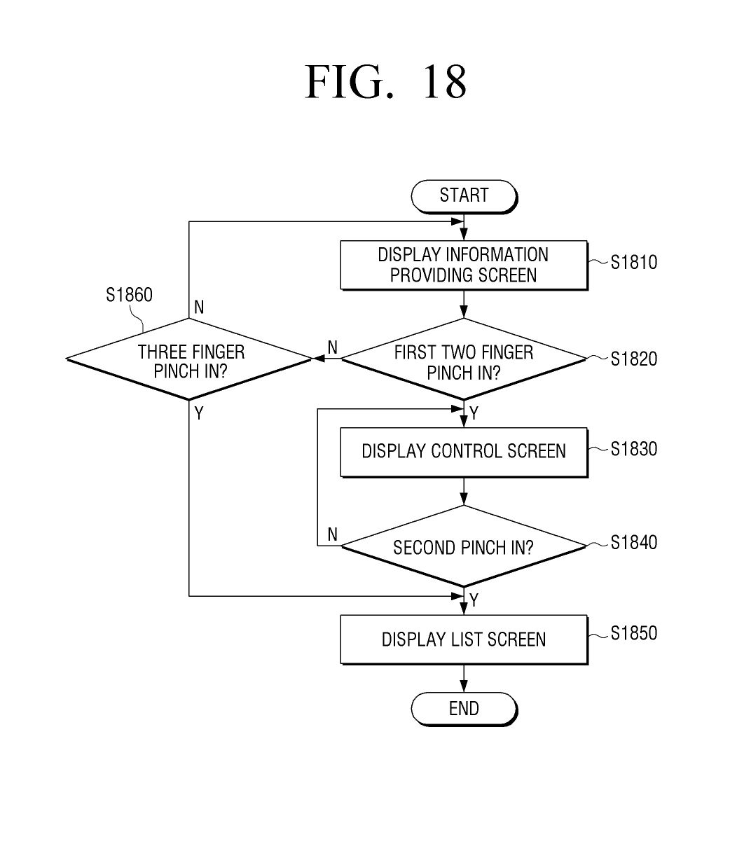

FIG. 18 is a flowchart illustrating a method for converting into a screen corresponding to an upper depth according to a pinch in interaction in the display apparatus according to an exemplary embodiment.

As described above, the display apparatus 100 may currently display the information providing screen corresponding to the lowermost depth. In response to a first pinch in interaction being inputted in the state in which the information providing screen corresponding to the lowermost depth is displayed, the display apparatus 100 may convert the currently displayed information providing screen to the control screen corresponding to the upper depth, and displays the control screen (S1810, S1820). Thereafter, in response to a second pinch in interaction being inputted, the display apparatus 100 may convert the currently displayed control screen into the list screen corresponding to the uppermost depth, and display the list screen (S1830, S1840).

For example, in response to the first pinch in interaction being inputted in the state in which the information providing screen providing detailed information on an audio outputted through the first speaker corresponding to the first content from among the first to third contents is displayed, the display apparatus 100 converts into the control screen for controlling an audio reproduction-related operation of the first speaker. In response to the second pinch in interaction being inputted in the state in which the control screen for the first speaker is displayed, the display apparatus 100 may convert into the list screen providing the content list including the first to third contents corresponding to the pre-registered first to third speakers, and display the list screen.

In response to the user interaction inputted by the user being a three-finger pinch in interaction in operation 1820, the display apparatus 100 may convert the information providing screen corresponding to the lowermost depth into the list screen corresponding to the uppermost depth, and display the list screen (S1860). That is, in response to the three-finger pinch in interaction being inputted, the display apparatus 100 may omit the step of displaying the control screen which corresponds to a separate intermediate depth, and directly convert the information providing screen corresponding to the lowermost depth into the list screen corresponding to the uppermost depth, and display the list screen.

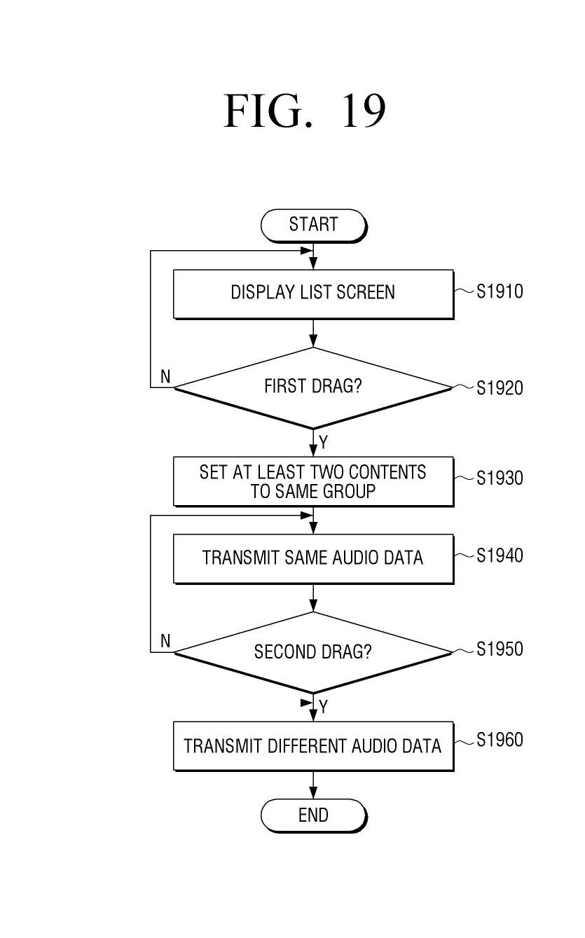

FIG. 19 is a flowchart illustrating a method for setting a group according to a drag interaction in the display apparatus according to an exemplary embodiment.

As shown in FIG. 19, in response to an audio application being executed, the display apparatus 100 displays a list screen corresponding to an uppermost depth (S1910). The list screen may be a screen which provides a content list on first to third contents corresponding to pre-registered first to third speakers 10 to 30.

In response to a first drag interaction being inputted in the state in which the list screen including the first to third contents is displayed, the display apparatus 100 may set at least two contents of the first to third contents included in the list screen to be grouped into the same group (S1920, S1930). In response to the at least two contents being set to the same group, the display apparatus 100 may transmit audio reproduction information including audio data on a corresponding audio to the AP apparatus 210 such that the same audio is outputted from the speakers corresponding to the at least two contents which are set to the same group (S1940). Accordingly, the speakers corresponding to the at least two contents which are set to the same group may output the same audio based on the audio reproduction information received from the hub apparatus 220 physically connected with the AP apparatus 210.

In response to a second drag interaction being inputted in the state in which the at least two of the first to third contents are set to the same group, the display apparatus 100 may negate the group setting of the at least two contents which are grouped into the same group, and transmit, to the AP apparatus 210, audio reproduction information including audio data on an audio differently outputted from each speaker corresponding to each content before the contents were grouped into the same group (S1950, S1960). Therefore, the speakers corresponding to the at least two contents which are ungrouped may output different audios based on the audio reproduction information received from the hub apparatus 220 physically connected with the AP apparatus 210.

The foregoing exemplary embodiments and advantages are merely exemplary and are not to be construed as limiting the inventive concepts. It should be understood that the exemplary embodiments can be readily applied to other types of apparatuses. Also, the description of one or more exemplary embodiments is intended to be illustrative, and not to limit the scope of the claims, and many alternatives, modifications, and variations will be apparent to those skilled in the art.

What is claimed is:

1. A display apparatus comprising:
an inputter configured to receive a touch input of a user;
a display configured to display one screen of a plurality of screens, wherein each screen corresponds to a depth according to a hierarchical structure; and
a controller configured to, in response to a pinch gesture being received through the inputter, control the display to convert a screen that is currently displayed into a screen corresponding to a higher depth than the screen that is currently displayed or a lower depth than the screen that is currently displayed, according to a type of the pinch gesture.

2. The display apparatus of claim 1, wherein, in response to an audio application being executed, the plurality of screens comprise at least one of a list screen which provides a content list comprising contents corresponding to a plurality of speakers that are pre-registered, a control screen for controlling a speaker corresponding to a content selected from the plurality of contents included in the content list, and an information providing screen which provides information about an audio outputted through the speaker corresponding to the selected content.

3. The display apparatus of claim 2, wherein, in response to a two-finger pinch out gesture being received in a state in which the list screen is displayed, the controller is configured to control the display to convert into the control screen, and, in response to a two-finger pinch out gesture being received in a state in which the control screen is displayed, the controller is configured to control the display to convert into the information providing screen.

4. The display apparatus of claim 3, wherein, in response to a two-finger pinch in gesture being received in a state in which the information providing screen is displayed, the controller is configured to control the display to convert into the control screen, and, in response to a two-finger pinch in gesture being received in a state in which the control screen is displayed, the controller is configured to control the display to convert into the list screen.

5. The display apparatus of claim 3, wherein, in response to a three-finger pinch out gesture being received in a state in which the list screen is displayed, the controller is configured to control the display to convert into the information providing screen, and, in response to a three-finger pinch in gesture being received in a state in which the information providing screen is displayed, the controller is configured to control the display to convert into the list screen.

6. The display apparatus of claim 2, wherein, in response to a drag gesture being received in a state in which the list screen is displayed, the controller is configured to set at least two contents from among the plurality of contents included in the list screen to be grouped into a same group, and
in response to a drag gesture being received in the state in which the at least two contents are grouped into the same group, the controller is configured to ungroup the at least two contents that are grouped into the same group.

7. The display apparatus of claim 6, further comprising a communicator configured to perform data communication with the plurality of speakers that are pre-registered via a relay apparatus, and
in response to a second content from among the plurality of contents being set to a same group as a first content from among the plurality of contents in a state in which an audio is outputted through a first speaker corresponding to the first content from among the plurality of contents, the controller is configured to control the communicator to transmit same audio data to the first speaker and the second speaker, wherein the first speaker and the second speaker correspond to the first content and the second content, respectively.

8. The display apparatus of claim 7, wherein, in response to the first content and the second content being ungrouped in a state in which the audio outputted from the first speaker is the same as the audio outputted from the second speaker, the controller is configured to control the communicator to transmit different audio data to the first speaker and the second speaker.

9. The display apparatus of claim 7, wherein, in response to audio being outputted from the first speaker and the second speaker corresponding to the first content from among the plurality of contents and the second content from among the plurality of contents, the controller is configured to control the display to display the first content and the second content differently than the other contents.

10. The display apparatus of claim 2, wherein the plurality of screens further comprise a speaker list for controlling the plurality of speakers that are pre-registered, and
wherein the controller is configured to perform audio setting on at least one of the plurality of speakers included in the speaker list according to a user command.

11. A control method of a display apparatus, the method comprising:
displaying one screen of a plurality of screens, wherein each screen corresponds to a depth according to a hierarchical structure;
receiving a touch input of a pinch gesture; and
in response to the pinch gesture being received, converting a screen that is currently displayed into a screen corresponding to an higher depth than the screen that is currently displayed or a lower depth than the screen that is currently displayed, according to the pinch gesture.

12. The control method of claim 11, further comprising executing an audio application according to a user command,
wherein displaying the one screen comprises, in response to the audio application being executed, displaying at least one of a list screen which provides a content list comprising contents corresponding to a plurality of speakers that are pre-registered, a control screen for controlling a speaker corresponding to a content selected from the plurality of contents included in the content list, and an information providing screen which provides information about an audio outputted through the speaker corresponding to the selected content.

13. The control method of claim 12, wherein the displaying comprises, in response to a two-finger pinch out gesture being received in a state in which the list screen is displayed, converting into the control screen, and, in response to a two-finger pinch out gesture being received in a state in which the control screen is displayed, converting into the information providing screen.

14. The control method of claim 13, wherein the displaying comprises, in response to a two-finger pinch in gesture being received in a state in which the information providing screen is displayed, converting into the control screen, and, in response to a two-finger pinch in gesture being received in a state in which the control screen is displayed, converting into the list screen.

15. The control method of claim 13, wherein the displaying comprises, in response to a three-finger pinch out gesture being received in a state in which the list screen is displayed, converting into the information providing screen, and, in response to a three-finger pinch in gesture being received in a state in which the information providing screen is displayed, converting into the list screen.

16. The control method of claim 12, further comprising:
in response to a drag gesture being received in a state in which the list screen is displayed, setting at least two contents from among the plurality of contents included in the list screen to be grouped into a same group; and
in response to a drag gesture being received in the state in which the at least two contents are grouped into the same group, ungrouping the at least two contents that are grouped into the same group.

17. The control method of claim 16, further comprising transmitting audio data to a speaker corresponding to at least one of the plurality of contents according to a user command, and
wherein the transmitting the audio data comprises, in response to a second content from among the plurality of contents being set to a same group as a first content from among the plurality of contents in a state in which an audio is outputted through a first speaker corresponding to the first content from among the plurality of contents, transmitting same audio data to the first speaker and second speaker, wherein the first speaker and the second speaker correspond to the first content and the second content, respectively.

18. The control method of claim 17, wherein the transmitting the audio data comprises, in response to the first content and the second content being ungrouped in a state in which the audio outputted from the first speaker is the same as the audio outputted from the second speaker, transmitting different audio data to the first speaker and the second speaker.

19. The control method of claim 17, wherein displaying the one screen comprises, in response to audio being outputted from the first speaker and the second speaker corresponding to the first content from among the plurality of contents and the second content from among the plurality of contents, displaying the first content and the second content differently than the other contents.

20. The control method of claim 12, wherein the plurality of screens further comprise a speaker list for controlling the plurality of speakers that are pre-registered, and
wherein the executing the audio application comprises performing audio setting on at least one of the plurality of speakers included in the speaker list according to a user command.

21. A method for controlling a plurality of speakers, the method comprising:
displaying one screen of a plurality of screens, wherein each screen corresponds to a depth according to a hierarchical structure;
identifying, for each content from among a plurality of contents, a speaker from among the plurality of speakers, that corresponds to each content;
receiving a gesture input;
converting from a screen that is currently displayed to a screen having a different depth in the hierarchical structure, according to a type of the received gesture input.

22. The method of claim 21, wherein in response to the received gesture input being a two-finger pinch out gesture when the screen that is currently displayed is a list screen for listing a plurality of contents, converting to a control screen for controlling an audio feature of an audio stream, and in response to the received gesture input being a two-finger pinch out gesture when the screen that is currently displayed is the control screen, converting to an information providing screen for providing information about an audio outputted through the speaker that corresponds to the content displayed on the control screen.

23. The method of claim 21, wherein in response to the received gesture input being a two-finger pinch in gesture when the screen that is currently displayed is an information providing screen for providing information about an audio outputted through the speaker that corresponds to the content, converting to a control screen for controlling an audio feature of an audio stream, and in response to the received gesture input being a two-finger pinch in gesture when the screen that is currently displayed is the control screen, converting to a list screen for listing a plurality of contents.

24. The method of claim 21, wherein in response to the received gesture input being a three-finger pinch out gesture when the screen that is currently displayed is a list screen for listing a plurality of contents, converting to an information providing screen for providing information about an audio outputted through the speaker that corresponds to the content.

25. The method of claim 21, wherein in response to the received gesture input being a three-finger pinch in gesture when the screen that is currently displayed is an information providing screen for providing information about an audio outputted through the speaker that corresponds to the content, converting to a list screen for listing a plurality of contents.
